(19) United States
(12) Patent Application Publication
(10) Pub. No.: US 2017/0066155 A1
(43) Pub. Date: Mar. 9, 2017

(54) CUTTING DEVICE AND A METHOD OF CUTTING WITH A CUTTING DEVICE

(71) Applicant: Lauri Ketonen, Kristiinankaupunki (FI)

(72) Inventor: Lauri Ketonen, Kristiinankaupunki (FI)

(21) Appl. No.: 15/249,850

(22) Filed: Aug. 29, 2016

(30) Foreign Application Priority Data
Sep. 3, 2015 (FI) 20150251
Sep. 30, 2015 (FI) 20155693
Oct. 22, 2015 (FI) 20155751
Jul. 13, 2016 (FI) 20165585

(51) Int. Cl. B27B 33/14; A01G 23/091; B27B 17/02; A01G 23/083

(52) U.S. Cl. CPC B27B 33/142; A01G 23/083; A01G 23/091; B27B 17/02

(57) ABSTRACT

A cutting device includes a generally planar guide bar having a peripheral groove. An endless saw chain is disposed around the guide bar and includes links and connector elements joining the links to each other to form an endless chain loop. The links include drive links and consecutive tooth links connected to a same one of the drive links. Each tooth link includes a cutting tooth protruding from one side of the saw chain. Consecutive cutting teeth of the tooth links are arranged to alternate to right and left sides relative to a plane defined by the guide bar. The saw chain is operably circulated around the guide bar groove for cutting.

### TECHNICAL FIELD

The invention relates to a cutting device. In addition, the invention also relates to a method of cutting with a cutting device.

### BACKGROUND OF THE INVENTION

The chain saw has become established as the cutting device, for example in felling machines making logs for sawmills. Disc saws are also used, but they have the drawback of a great weight and space requirement. Sufficiently rapid cutting is achieved with both of these devices. Therefore splitting, which reduces the quality of sawn goods, cannot occur during cutting.

So-called guillotine cutting can also be used with small trees, mainly cut for use in energy production. Though trees cut for energy production can also be cut using a chain saw, a chain saw is liable to malfunction when used for this purpose.

However, a chain saw has significant safety problems. One of these is the possible breaking of the chain. The high speed of the chain when cutting causes parts of it to be thrown around if it breaks. For this reason, the cabs of felling machines must be equipped with windshields as much as 25-30 mm-thick. Such a special windshield increases the price of a timber harvester. Despite this, parts of the chain nevertheless sometimes penetrate the glass, leading even to fatalities. Doubling the speed of the chain quadruples the kinetic energy of the parts.

FIG. 6 shows cutting taking place using a saw chain 10′ according to the prior art. The saw chain 10′ has, as parts, a drive link 12, a tooth link 21, and an intermediate link 14. The intermediate link can also be called a side link. The tooth link 21 includes a cutting edge 24 and also a so-called adjustment tooth 15. The cutting depth H of the cutting edge 24 is adjusted using the adjustment tooth 15. The saw chain 10′ runs in a groove 22 arranged in the guide bar 11. The saw chain 10′ is driven by a drive wheel 16 and the guide bar 11 includes a sprocket 17 arranged at its end for the saw chain 10′. To perform sawing, the guide bar is, in turn, rotated relative to a pivot point arranged for it. The rotation, which can also be called, when in one direction, pressing the guide bar 11 down, and in the opposite direction, lifting it up, takes place, for example, using a hydraulic cylinder (not shown).

FIG. 6 also uses reference number 18′ to show the object to be cut using the saw chain 10′. It can be, for example, a twig or branch with a diameter of, for example, about 35 mm. As can be seen from the FIG., when cutting starts, the twig or branch 18′ can be located in the saw chain 10′ on top of an intermediate link 14 formed by side plates 25 between the tooth links 21. Such a situation can arise very typically even during felling sawing. Even if the tree being felled is of a large diameter, there can often be branches in its butt area. In addition the branches can be very hard. Before the saw chain 10 starts moving, such a branch or twig can occur at an intermediate link 14 of the saw chain 10′.

When the saw chain 10′ starts to move in the direction S from the situation according to FIG. 6, as shown in FIG. 6, the adjustment tooth 15 sinks partly into the wood 18′ and the cutting depth of the cutting edge 24 can be as much as Hₘₐₓ. If the normal depth of the cutting edge 24 is about 1.2 mm, Hₘₐₓ can be as much as about 5 mm. This causes a large point load on the cutting edge 24 and in turn, through the rivets 19, also on the saw chain 10′ itself. This can cause the saw chain 10′ to break.

Yet another problem relating to saw chains known from the prior art, is their stretching. The saw chain should be tightened from time to time, so that it will remain on top of the guide bar. Although automatic chain tensioners are known, they have a relatively large effect on the price of the felling head.

### SUMMARY OF THE INVENTION

The present invention provides a cutting device, which has improved durability and usability properties. The invention also provides a method of cutting with a cutting device, which improves the durability of the saw chain and reduces the power consumption of the cutting device. The cutting device according to the invention includes a generally planar guide bar having a peripheral groove. An endless saw chain is disposed around the guide bar and includes links and connector elements joining the links to each other to form an endless chain loop. The links include drive links and consecutive tooth links connected to a same one of the drive links. Each tooth link includes a cutting tooth protruding from one side of the saw chain, and consecutive cutting teeth of the tooth links are arranged to alternate to right and left sides relative to a plane defined by the guide bar. The saw chain is operably circulated around the guide bar groove for cutting.

Thus, owing to the invention several tooth links are fitted consecutively, i.e. connected to the same one drive link. This improves the durability of the saw chain during timber cutting and thus prevents the breaking of the chain. In addition, this can increase the saw chain's cutting effect. Further, in this way the thickness of the windshield of a timber harvester can be reduced, which in turn reduces the related investment costs.

The drive links may fitted in the groove of the guide bar on an opposite side of the saw chain relative to the cutting teeth, and the tooth links and the drive links may be alternately disposed in the saw chain. By implementing the saw chain without widely spacing its tooth links, i.e. more closely than in the prior art and without link intervals that are free of tooth links, the external construction of the saw chain is made more even. By means of the invention, the tree being cut no longer so easily reaches the base of the saw chain, i.e. the level of the outer edge of the side plates, as happens in saw chains known from the prior art implemented with widely-spaced tooth links. This avoids loading peaks acting on the saw chain. In addition, the saw chain better stays in the groove arranged for it in the guide bar (i.e., on “top” of the guide bar).

The cutting teeth in consecutive tooth links may be arranged to cut on opposite sides relative to each other. They then cut the tree from alternating opposite sides relative to a plane defined by the guide bar, and also relative to the sawing groove.

The saw chain may have a width that is 10%-40% greater than a width of the guide bar.

Each cutting tooth may include an adjustment tooth, and in the consecutive links, the adjustment tooth of a following link is disposed next to a position of a rear edge of the cutting tooth of a preceding link.

A bite angle of each cutting tooth may be 0.5-7 degrees.

A depth of a space between consecutive cutting teeth may be more than 40% of a height of the cutting tooth from a base of the cutting tooth.

A clearance of the connector elements of the saw chain may be arranged to limit the sidesway of the tooth links.

The guide bar may have a length in a range of 30-100 cm.

The cutting device may include a hydraulic saw motor having a power in a range of 20-100 kW.

The cutting device may be in combination with a tree handling device, the tree handling device including a gripper for gripping a tree.

The cutting device may be in combination with a timber harvester, the timber harvester including a boom and the cutting device being operably mounted on the boom.

The timber harvester may further include a motorized base machine; a cab attached to the base machine, the cab including a windshield; and a crane attached to the base machine, the crane including the boom.

The windshield of the cab may have a thickness of 5-15 mm.

A method of cutting with a cutting device in accordance with the invention includes the steps of: gripping a tree before cutting it; circulating the saw chain at a speed of 20-35 m/s; and cutting the tree using the cutting device, whereby twisting of the saw chain in a sawing groove is reduced by the arrangement of the tooth links consecutively in the saw chain and joining the several tooth links to a same drive link.

The step of cutting the tree may further include the steps of: operably circulating the saw chain around the guide bar using a drive device; rotating the guide bar against the tree being cut; and controlling the rotation of the guide bar against the tree being cut on the basis of one of the speed of the saw chain and another variable.

With the aid of the invention, the saw chain's cutting capacity is almost roughly doubled. As the saw chain's cutting capacity is greater, the speed of the saw chain can, for its part, be reduced. Despite the reduction in chain speed, a cutting speed close to the former one is maintained, but the kinetic energy of the chain drops considerably. The reduction in speed is followed in turn by a saving in the energy consumption/power requirement of the work machine.

When the tooth links are more closely spaced in the saw chain, the saw chain can surprisingly be narrowed. This also results in a smaller power requirement in the cutting device and thus a saving in energy. The durability of the saw chain also improves.

When applying the saw chain according to the invention in the cutting device of a timber harvester, the rotation of the guide bar, i.e. the pressing of the guide bar against the tree being cut and the lifting back of it, can be implemented, for example, in such a way as to take into account the current rotational velocity of the saw chain.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective view of a timber harvester, seen at an angle from in front;

FIG. 2 is a plan view of the timber harvester of FIG. 1;

FIG. 3 is a perspective view of one tree-handling device, which includes a cutting device equipped with a saw chain, and which is used in the timber harvester of FIGS. 1 and 2;

FIG. 4a is a side view of a saw chain according to the invention in connection with a guide bar;

FIG. 4b is a side view of the saw chain according to FIG. 4a and the tree intended to be cut in connection with the saw chain when starting cutting;

FIG. 5 is a plan view of the saw chain or saw-chain blank according to the invention;

FIG. 6 is a side view of a saw chain according to the prior art when cutting a tree;

FIG. 7 is a schematic view illustrating the paths of travel in a cutting situation of a saw chain according to the prior art and a saw chain according to the invention; and

FIG. 8 is a side view of another saw chain according to the invention and the tree intended to be cut in connection with the saw chain when starting cutting.

### DETAILED DESCRIPTION OF THE INVENTION

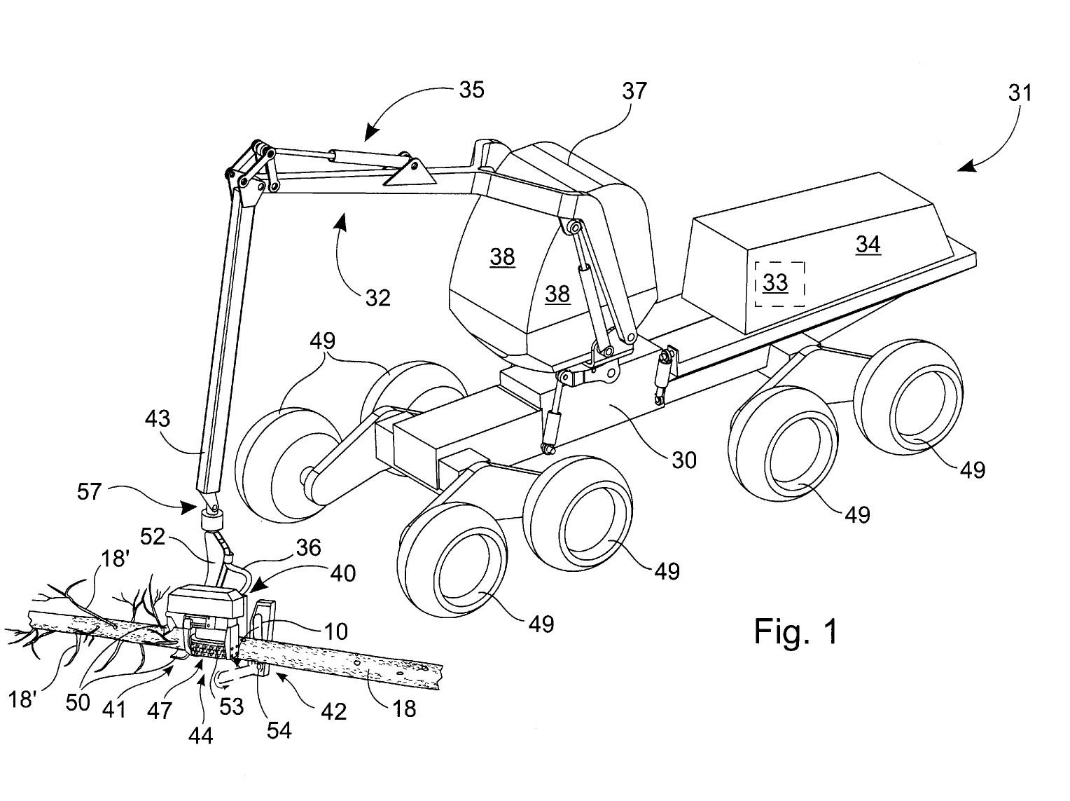

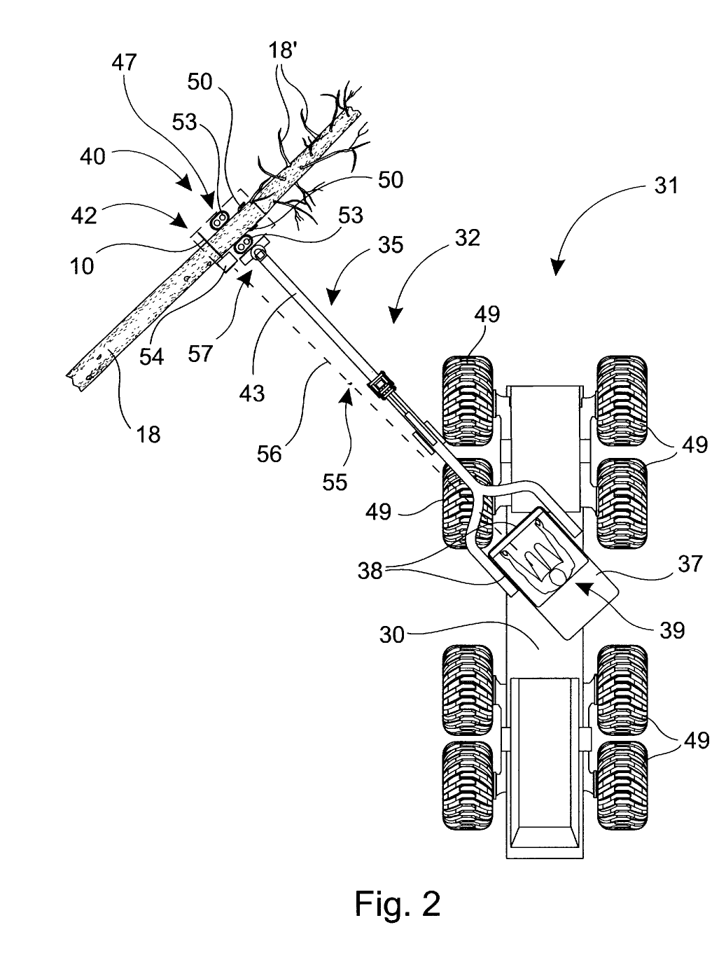

FIG. 1 shows schematically one example of a timber harvester 31 seen at an angle from in front and in FIG. 2 from above. In timber harvesters 31, there is usually a crane 32, fitted on a base machine 30, with a moving set of working booms 35, at the end of the last boom of which, i.e. in this case boom 43, a tree-handling device 40 is attached, for example in a pivoted manner. The pivoting of the tree-handling device 40 to the boom 43 can be made, for example, according to the prior art using two transverse rotational pivots in different directions to each other, more generally using a pivoted joint. This can also be referred to as suspension 57.

Between the tree-handling device 40 and the pivoted joint there can be a rotation device 51, which is also generally referred to as a rotator. With the aid of the rotation device 51, the tree-handling device 40 can be rotated without limit around the axis of rotation of the rotation device 51. The flow of pressure-medium required by the tree-handling device 40 (for example, a hydraulic saw motor 54) can be brought through the working booms 35 of the crane 32 with the aid of the hoses 36, more generally, pressure-medium lines from the pressure-medium pump 33 of the base machine 30. In order to create pressure, the pressure-medium pump 33 is run, for example, with the aid of the engine 34 of the base machine 30. The motorized base machine 30 includes a cab 37, which is equipped with a windshield 38. In the cab 37, there is a seat for the driver 39 of the timber harvester 31, who controls, for example, the crane 32 and the tree-handling device 40, more generally the operation of the timber harvester 31.

When working, the distance of the tree-handling device 40 from the cab 37 and the driver in it can be several meters, even as much as ten meters. Thus the length of the set of working booms 35 is several meters. It is then impossible for the driver 39 to see the sawing line of the object to be cut, which is made still more difficult by the rotating guide bar.

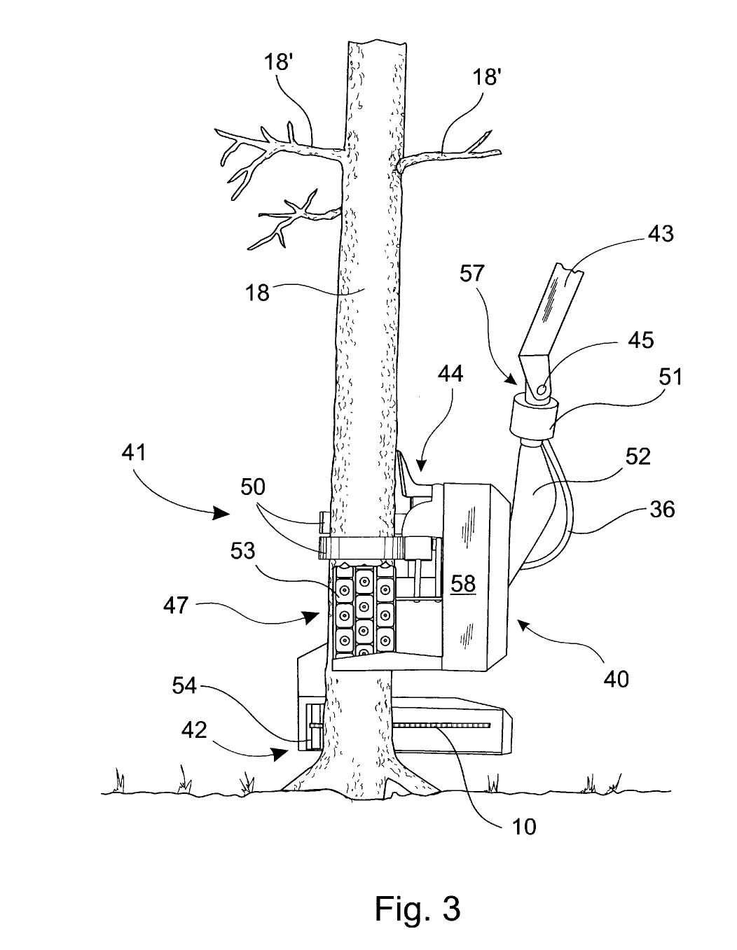

The harvester 31 is equipped with, for example, wheels 49 or crawler tracks arranged to circulate around them (not shown) and sufficient ground clearance. By means of the wheels 49 and/or the crawler tracks and the ground clearance, the harvester 31 is able to move off-road. The tree-handling device 40 can be said to include an operating unit 44, in which the basic component is a cutting device 42, a feed device 47, and stripping blades acting as grab claws 50. Their operation is described in greater detail hereinafter with reference to FIG. 3.

FIG. 2 also illustrates the cutting device 42 located in the tree-handling device 40 and particularly the problem relating to its saw chain 10, which the invention solves. If the saw chain 10 breaks, pieces of chain 55 are thrown from it. If the tree-handling device 40 is in a suitable line relative to the harvester's 31 cab 37, the chain pieces 55 are aimed at the cab 37 and the driver 39 sitting in it. The line of flight of the chain pieces 55 is shown in FIG. 2 by the reference number 56. Despite the cab's 37 windshield 38, the chain pieces 56 may penetrate it and thus even cause the death of the driver 39. In addition, the chain pieces 56 also fly into the surroundings of the machine 31, leading to large safety zones around the machine 31.

FIG. 3 shows a rough schematic diagram of one example of the tree-handling device 40 used in FIGS. 1 and 2 seen from the side in the position in which a tree 18 is begun to be felled. In connection with the invention, the tree-handling device 40 can be understood very widely. A very typical series of processing operations, which are performed using the tree-handling device 40, is the standing felling of the tree 18, the stripping of the branches 18′, and the cutting of the stripped trunk into parts of regular length as the stripping progresses. Similarly, the processing performed by the tree-handling device 40 can also be the individual operations referred to above or various combinations of them. It can be, for example, stripping of tree trunks, cutting performed in connection with stripping, and/or collection of one or more ready stripped tree trunks, for example, for the stacking or loading of the trees. One or even more trees may be handled at a time, in which case it can be called the bundle handling of trees.

The tree-handling device 40 shown in FIG. 3 can also be called a harvester or processor head. In FIG. 3, the suspension device 52 and operating unit 44 of the tree-handling device 40 are in the felling position. The tree-handling device 40 includes its rotation apparatus (not shown), a suspension device 52, and an operating unit 44. The tree-handling device 40 is suspended from the boom 43 on the pivot point 45. The boom 43 can be part of the crane 32 of a base machine 30, such as a timber harvester 31 or a special harvester, or the boom of an excavator or other similar moving base. The control and pressurized oil of the tree-handling device 40 comes from the base machine 30 in the manner already referred to.

To rotate the operating unit 44, the tree-handling device 40 includes an operating device for rotating the operating unit 44 between the felling position and the stripping positions. In FIG. 3, the tree-handling device 40 is in the felling position. The operating unit 44 is then mainly vertical. The stripping position is achieved when the operating unit 44 is rotated by the operating device by about 90° from the position shown in FIG. 3. As a result of the rotation, the operating unit 44 is mainly horizontal, as shown in FIGS. 1 and 2. The operating device for rotating the operating unit 44 can be, for example, a hydraulic cylinder located in the casing 58, but it can also be some other operating device suitable for the purpose.

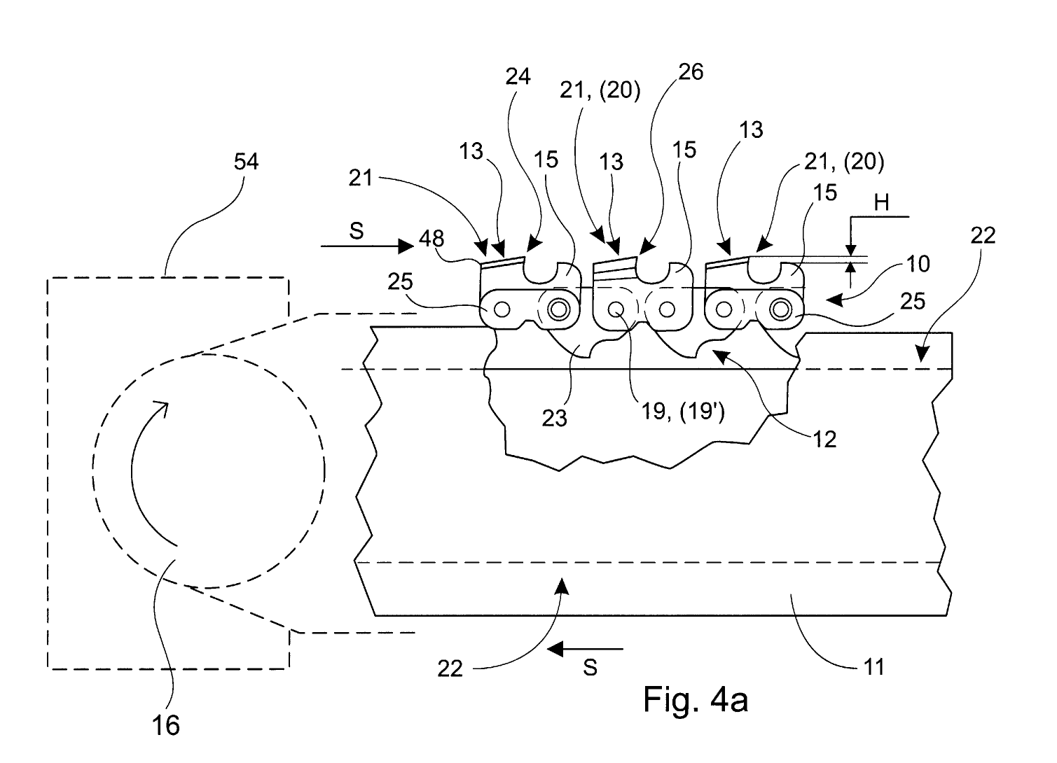

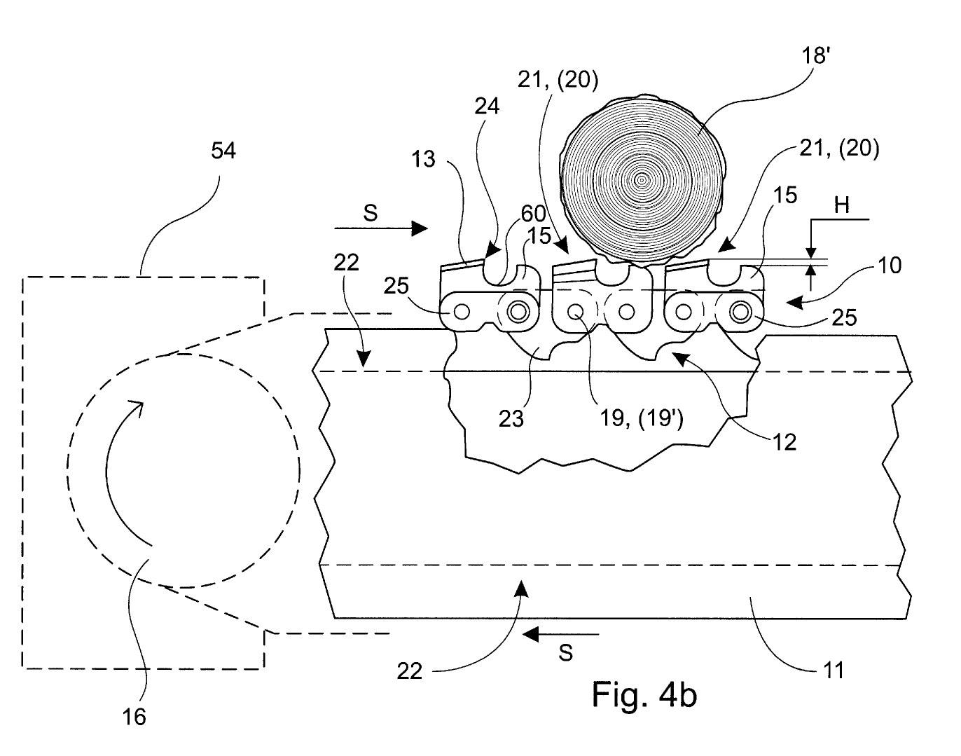

The tree-handling device 40 also includes a cutting device 42. The cutting device 42 is now a rotating saw chain saw. It is located at the end of the tree-handling device 40 and thus also of the operating unit 44. The felling of the tree 18, i.e. felling cutting, can be performed using the cutting device 42 and, in addition, also the cutting of the tree 18 into regular lengths. In addition to the saw chain 10, the cutting device 42 also includes a rotating guide bar 11 (FIGS. 4a and 4b), a saw-chain 10 drive wheel 16 (FIGS. 4a and 4b), by which the saw chain 10 is rotated around the guide bar 11, and guide bar 11 rotation means for performing sawing. Using the rotation means, the guide bar is pressed, i.e. loaded against the tree 18 being sawed. In addition, the rotation means also return the guide bar 11 with the saw chain 10 back to its home position for the next sawing. FIG. 1 shows the extreme positions of the guide bar 11 and an arrow showing the back-and-forwards rotational movement between them of the guide bar 11.

In principle, the tree-handling device 40 operates by gripping the tree 18 with the gripping means 41 of the operating unit 44. An example of the gripping means 41 are the opening and closing grab claws 50. The grab claws 50 can also have a blade function for stripping the tree 18 of branches 18′. The feed device 47 can also act as the gripping means. The feed device 47 can be, for example, rollers, crawler tracks 53, or even a pulsed feed. Instead of processing an individual tree 18, the gripping means 41 and/or the feed device 47 can also be used to perform the bundle processing of trees.

Once the standing cutting of the tree 18 has been performed using the cutting device 42, the operating unit 44 is turned to the horizontal position to strip the tree 18 of branches 18′ and cut it into parts of regular length. After that, the tree-handling device 40 is moved relative to the tree 18 by the crawler tracks 53 of the feed device 47. As a result, the tree 18 travels through the operating unit 44. When the grab claws 50 are closed they are tightly against the trunk of the tree 18 and at the same time as the tree 18 moves relative to the operating unit 44 the stripping blades in the edges of the grab claws 50 cut the branches 18′ off the tree 18. When a part of the desired length of the tree 18 has been stripped, the trunk is sawn into a regular-length part with saw chain 10 of the cutting device 42. After this, stripping continues by feeding the tree through the grab claws 50.

FIG. 4a shows a side view of one example of the saw chain 10 according to the invention on a guide bar 11. Correspondingly, FIG. 4b shows a side view of the same saw chain 10 when the saw chain 10 is in contact with the tree 18 to be cut, when cutting begins. The saw chain 10 is thus intended, for example, for the cutting device 42 of the tree-handling device 40 shown in FIG. 3. The saw chain 10 includes links 20, which are connected to each other by connector elements 19′. Here the connector elements 19′ are rivets 19. In the saw chain 10, the links 20 are connected to each other by rivets 19 in such a way that the saw chain 10 is an endless chain loop, which can be fitted to rotate in a groove 22 arranged in the guide bar 11. Thus the links 20 are rotatably pivoted to each other through the rivets 19, to permit the forward and backward movement of the saw chain around the guide bar 11. The guide bar 11 is an elongated flange which can also be called a cutting flange or blade plate. Correspondingly, the saw chain 10 can also be called a blade chain. In an as such known manner the groove 22 is on the outer edge of the guide bar 11, in the upper edge and correspondingly also in the lower edge. The saw chain 10, which is formed as an endless chain loop, can be said to have an inside and an outside. On the inside, the chain loop formed by the saw chain 10 is to be arranged to rotate in the groove 22 arranged in the guide bar 11. Correspondingly, the outside of the saw chain 10 is to be arranged against the tree 18 for its cutting, i.e. sawing. The saw chain's 10 cutting elements are on the outer edge of the saw chain 10.

As links 20, the saw chain 10 includes tooth links 21 and drive links 12. A tooth link 21 is formed of a cutting tooth 13 protruding from one side of the saw chain 10 and a side plate 25. The cutting tooth 13 in turn includes in this embodiment an optional depth adjustment tooth 15 and cutting edge 24 fitted to outer side of the saw chain 10. In the endless chain loop formed by the saw chain 10, this side is on the outside of the saw chain 10. In the opposite direction relative to the direction of rotation S of the saw chain 10 there is in the tooth link 21 first an adjustment tooth 15, which can also be called a depth or depth-adjustment tooth. The adjustment tooth 15 can be a blunt protrusion made in an as such known manner in the cutting tooth 13. The adjustment tooth 15 adjusts, in an as such known manner, the cutting depth H of the cutting edge 24 following the adjustment tooth 15, in the opposite direction to the direction of rotation S of the saw chain 10. The adjustment tooth 15 travels on the surface of the tree 18. It determines how deeply H the cutting edge 24 of the cutting tooth following it bites into the tree 18 being sawn.

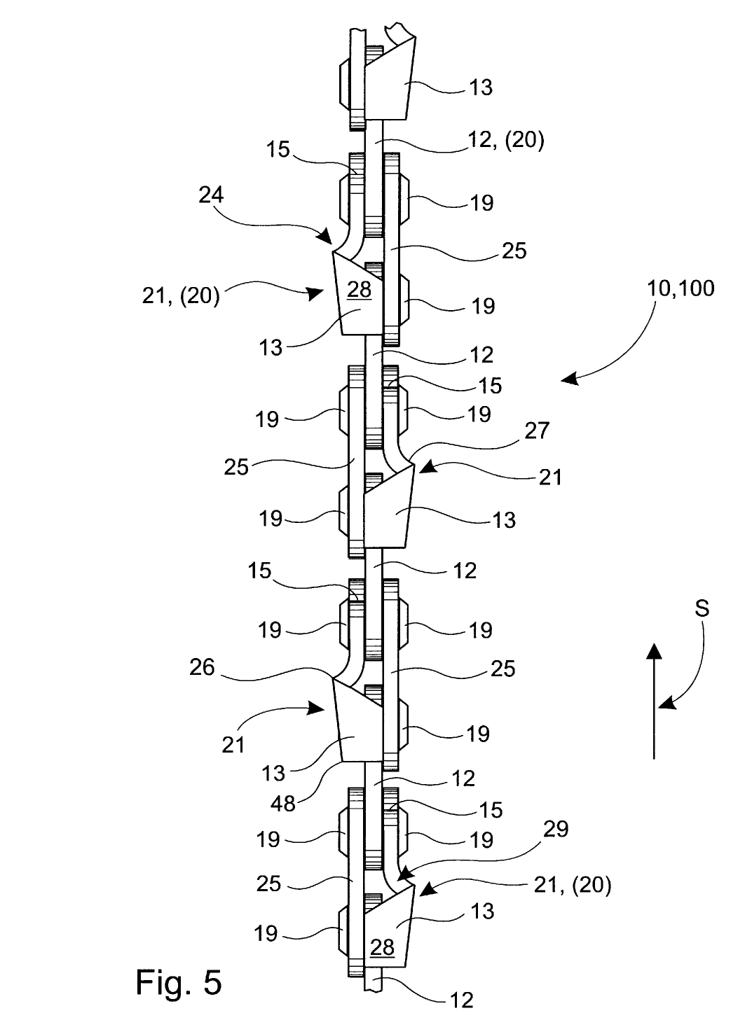

For its part, the cutting edge 24 includes, following an as such known principle, a cutting corner 26 arranged in its upper corner on the side of the adjustment tooth 15, and the side plate 27 of the tooth link 21 (FIG. 5). The cutting corner 26 and side plate 27 of the tooth link 21 cut the tree's 18 fibers by cutting the tree 18 by slicing, i.e. chipping. In addition, the cutting tooth 13 also includes a smooth shaping, the cutting corner 29 (FIG. 5), arranged in its upper plate 28. This guides the chip cut from the tree 18 away from the sawing groove formed in the tree 18 and at the same time also away from contact with the saw chain 10. Thus, the cutting corner 29 lifts the cut wood chips up and out of the sawing gap. There are holes in the cutting tooth and side plate 25 for the rivets 19. By these the tooth link 21, formed by the cutting tooth 13 and side plate 25, is attached to the preceding and following links 20 in the direction of rotation S of the saw chain 10.

The drive links 12 belonging to the links 20 can be fitted to the opposite side of the saw chain 10 relative to the side of the possible adjustment tooth 15 and cutting edge 24 of the cutting tooth 13, in the groove 22 in the guide bar 11. Thus, by using the drive links 12, the saw chain 10 can be fitted into the groove 22 in the guide bar 11, where it circulates the guide bar in the direction of rotation S. The drive links 12 include drive tongues 23 on one edge, being the opposite side of the saw chain 10 to the cutting edge 24 and possible adjustment tooth 15. The drive tongues 23 fit into the groove 22 in the guide bar 11. In addition, the drive tongues 23 are shaped to also suit the shape of the outer circumference of the drive and sprockets 16, 17. In addition to the drive tongues 23, there are holes in the drive links 12 for rivets 19. The drive link 12 is attached by these to the preceding and following links 20. The parts of the tooth link 21, the cutting tooth 13 and side plate 25, lie on each side of the drive link 12 at the rivet holes, to connect the links 20 to each other in a pivoted manner, i.e. rotatably.

Several tooth links 21 are fitted consecutively to the saw chain 10. Thus the saw chain 10 has on one or more sections tooth links 21 immediately on both sides of the drive link 12, in the direction of rotation S of the saw chain 10. Owing to this in the travel direction of the saw chain 10 consecutive tooth 21 links are connected to the same drive link 12. In the case according to the presented embodiment, every second link 20 of the saw chain 10 is a tooth link 21 and every other a drive link 12. Thus in the saw chain 10, a tooth link 21 and a drive link 12 are arranged to alternate as links 20 over the entire length of the saw chain 10 and thus also over the entire chain loop. Thus, the number of tooth links 21 in the saw chain 10 is double that in a saw chain 10′ according to the prior art.

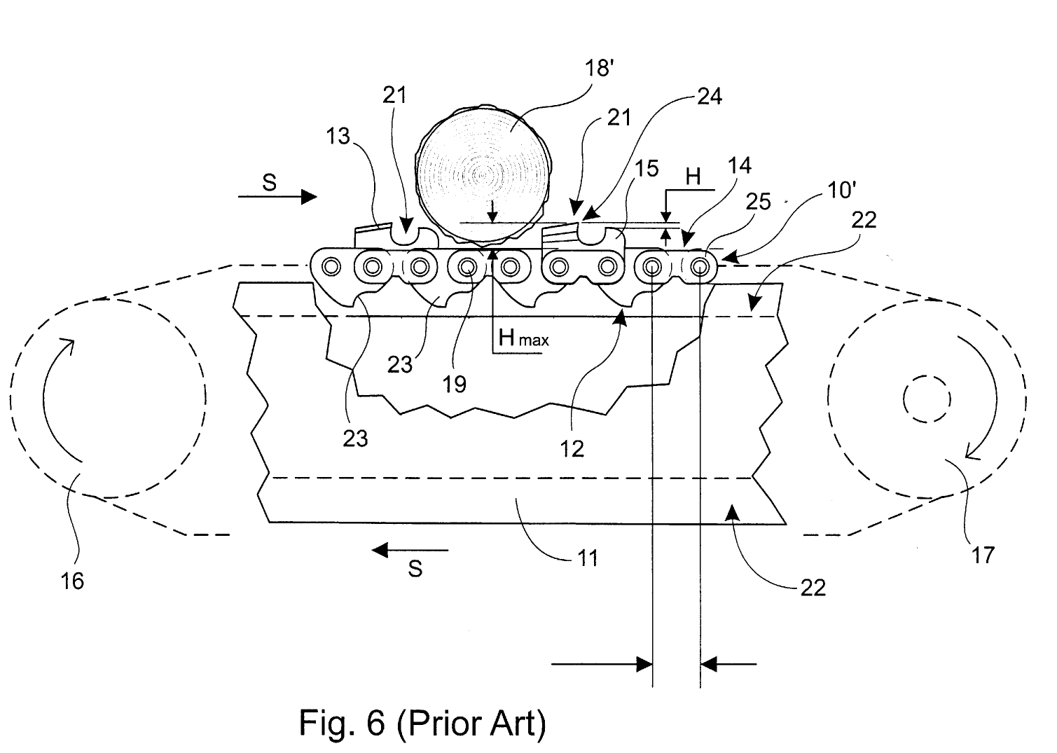

It can be seen from FIG. 4b that, when starting cutting, the use of such a link arrangement significantly limits the entry of the tree 18 intended to be cut by sawing to the base 60 of the saw chain 10, i.e. to the level of the outer edge of the lower side plates 25, as happens in the case of the intermediate links 14 formed from only side plates 25 (FIG. 6). Thus, this avoids the biting of the cutting tooth 13 too deeply, which stresses the saw chain 10 and is typically precisely what breaks the saw chain 10. In other words, by removing the intervals free of tooth links, i.e. the intermediate links 14 formed only from side plates 25, the travel of the tree 18 against the saw chain 10 is evened. Thus the tree 18 travels in a straighter line, i.e. more evenly against the outside of the chain loop formed by the saw chain 10. Thus, owing to the invention, the saw chain 10 has no links at all formed from only side plates 25. This avoids chipping of the tree 18 that takes place too deeply on the cutting edge 24 of the cutting tooth 13. In this way, the cutting tooth 13 cannot have an excessive cutting depth Hₘₐₓ. On account of this, large point loads are not directed to the saw chain 10. Correspondingly, the saw chain 10 places smaller surface pressures on the guide bar 11.

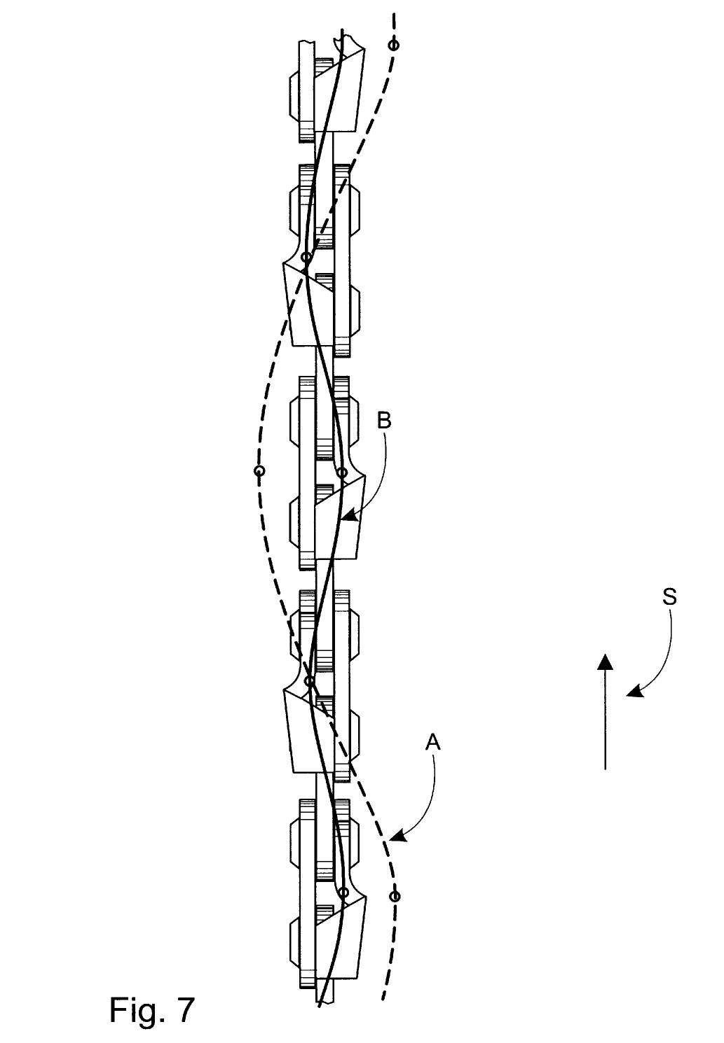

In consecutive tooth links 21, the cutting teeth 13 are arranged to cut on opposite sides to each other, i.e. to be in opposite directions. The cutting teeth 13 can then be said to be alternately right-handed and left-handed. Further in other words, the consecutive cutting teeth 13 of the saw chain 10 are arranged to alternate to the right and left sides relative to the plane defined by the guide bar 11. First of all, this ensures that the sawing groove formed by the saw chain 10 in the tree 18 becomes straight. In addition to this, it has been observed surprisingly in pilot-stage tests, that in this way, as also more generally by arranging cutting teeth 13 in each link, the avoidance due to the sawing force appearing in the sawing situation in the saw chain 10 is also reduced. FIG. 7 shows schematically an example of this. The path of travel in the sawing situation of a saw chain 10′ according to the prior art is shown with a broken line and the reference A and the path of travel in a sawing situation of a saw chain 10 according to the invention is shown with a solid line and the reference B. The avoidance appears precisely, for example, in saw chains 10′ known from the prior art, in which there are one, two, or even more intermediate links 14 formed from only side plates 25 consecutively between the tooth links 21 (FIG. 6) before the next tooth link 21.

Through the invention, when link intervals empty of tooth links have been even entirely removed from the saw chain 10, the saw chain 10 can avoid less in the sawing groove the tree 18 being cut, as seen in FIG. 7. In other words, due to the increased tooth link density of the saw chain 10, the tooth links 21 of the saw chain no longer have the possibility to avoid the wood, because in the sawing situation the saw chain 10 is effectively stiffer. Because the tooth links 21 follow each other more densely in the saw chain 10 than in known chains, when the consecutive tooth links 21 are in the sawing groove they prevent this avoidance more effectively. The tooth links 21 are then forced to bite into the wood 18 more effectively and thus sawing too takes place more effectively. This is, in turn, followed by the property that the sawing groove, which the saw chain bites when cutting the tree 18, becomes wider than with known saw chains 10′ with link intervals free of tooth links, in which the saw chain 10′, brought to a head can wind, twist, and rotate in the groove 22 in the guide bar 11, travelling from side to side between the consecutive tooth links 21. A narrower sawing groove results from this avoidance in the sawing groove due to the winding of the saw chain 10′.

In the applicant's pilot-stage tests, measurements have been made of the dynamic widths of various saw chains. Here the term dynamic width of the saw chain refers to the width of the sawing groove made by the saw chain. Due to the cutting forces, the cutting teeth of the saw chain then seek to avoid the wood in the sawing groove and the width of the sawing groove is not the same as the theoretical width of the saw chain. Using a saw chain 10′ known from the prior art a dynamic width of 8.4+0.2 mm was obtained with a new saw chain and correspondingly 7.9+0.2 mm with a slightly-used saw chain. The tendency of the cutting teeth 13 of the saw chain 10′ to avoid the wood 18 being cut was noted to be the greater, the blunter the cutting tooth 13 of the tooth link 21. For its part, using a saw chain 10 according to the invention the dynamic width of the saw chain 10 was as much as 9.2+0.2 mm. The intermediate links 14 formed of only side plates 25 in the saw chain 10′ known from the prior art permitted a greater deformation in the saw chain 10′. This results, in known saw chains 10′, in the cutting teeth 13 seeking to avoid the wood in the sawing groove and thus the sawing groove becoming narrower. In the measurements, the width of the guide bar 11 was 6.3 mm.

The theoretical sawing groove of the saw chains 10′, 10 is 10+0.2 mm. On the basis of the mechanical measurements made by the applicant for the saw chains 10, 10′, the saw chain 10, 10′ narrows in sawing due to its avoidance property by about 0.4 mm for every rivet 19 i.e. pivot. Thus the saw chain 10 according to the invention narrows about 0.8 mm between consecutive cutting teeth 13. For its part, a saw chain 10′ known from the prior art narrows correspondingly about 1.6 mm due to the four rivets 19, i.e. pivots, between the consecutive cutting teeth 13. In other words, a clearance of the connector elements 19 of the saw chain 10 is arranged to limit the sidesway of the tooth links 21. The gap in the rivets 19 may be, for example, 0-0.1 mm. In addition, it was noted that, if the cutting teeth 13 bite too much, the sawing groove can also widen by a corresponding amount for each pivot, so that the saw chain makes the sawing groove wider.

The invention also increases the service life of the guide bar 11 and reduces its need for maintenance. As, through the invention, the cutting teeth 13 cannot avoid the wood 18 so much being sawn during sawing, the saw chain 10 cannot twist, i.e. tilt, as greatly as in the case of a saw chain 10′ according to the prior art. Thus also the travel of the saw chain 10 in the guide bar 11 is straighter. Thus, the support of the saw chain 10 takes place, instead of in the groove 22 of the guide bar, in the sawing groove using the cutting teeth 13 of the saw chain 10, particularly their sides, against the wood being sawn. Thanks to the densely arranged cutting teeth 13 of the saw chain 10, the support of the saw chain 10 comes more from the consecutive cutting teeth 13 supported in the sawing grove than from the groove 22 in the guide bar 11. In turn, this results in the guide bar 11 and especially the groove 22 in it not wearing as much as happens with saw chains 10′ according to the prior art, in which the saw chain 10′ is able to twist and rotate in the groove 22 in the guide bar 11. Through the saw chain 10 according to the invention, the guide bar 11 has in this case a longer life. In addition, as a result of the reduced twisting and rotation the saw chain 10 according to the invention also remains better in place on top of the guide bar 11.

The enlarged sawing groove resulting from the saw chain 10 according to the invention permits the narrowing of the physical construction of the saw chain 10. According to one embodiment, the width of the saw chain 10 can be, for example, 10-40%, preferably 15-30% greater than the width of the guide bar 11. Here the width of the saw chain 10 can refer to the distance between the cutting corners 26 of the cutting teeth 13 cutting on opposite sides. The saw chain 10 can be implemented narrower by, for example, parts of 1.6 mm saw chain. The construction, which is narrower relative to known saw chains, in turn means that the power required to drive the saw chain 10 (to rotate it around the guide bar 11) can be reduced.

The applicant has observed in pilot-stage tests that only in the middle stage of sawing large trees with a diameter of more than 30 cm, i.e. in the case of the sawing point of the greatest diameter, the sawdust leaving the sawing groove may block the saw chain 10. At this point this limits the cutting speed. But as sawing progresses from this, and the diameter of the sawing point again diminishes, i.e. in the final stage of cutting, the cutting speed again increases. Thus, the tree 18 is not able to split.

In addition to the saw chain 10, the invention equally relates to a tree-handling device 40, of which an example is shown above in FIG. 3. The tree-handling device 40 includes gripping means 41 for gripping the tree 18 for cutting, and a cutting device 42. The cutting device 42 includes a guide bar 11 equipped with a groove 22. A saw chain 10 is arranged to rotate in the groove 22 in order to cut the tree 18. In addition, the guide bar 11 is arranged to rotate to perform sawing.

The cutting device 42 also includes a drive wheel 16 (FIGS. 4a and 4b). The drive wheel 16 is typically at the end of the guide bar 11, from where the guide bar 11 rotates when cutting the tree 18. The saw chain 10 is arranged to run via the drive wheel 16 in order to circulate around the guide bar 11. The inside of the endless chain loop formed by the saw chain 10 is arranged to fit the outer circumference of the drive wheel 16 to transmit power from the drive wheel 16 to the saw chain 10. For this purpose, there is shaping in the drive wheel 16 that is compatible with the drive tongues 23 of the drive links 12 of the saw chain 10. The drive wheel 16 is driven by a drive device, a hydraulic saw motor 54, which can be hydraulically operated. It is controlled by valves and their control means.

The cutting device 42 also includes a guide bar 11 rotation means (not shown). The guide bar 11 with its drive wheel 16 is fitted at one end rotatably to the cutting device 42 in order to perform cutting of the tree 18 using the saw chain 10. The rotation means can be, for example, a hydraulic cylinder fitted between the guide bar 11 and the structures of the tree-handling device 40. The hydraulic cylinder has a pressing movement and a lifting movement. With the pressing movement, the guide bar 11 and the saw chain 10 rotating around it, more generally the cutting saw, is pressed from the guide bar's 11 home position against the tree 18. Correspondingly, with the lifting movement, the guide bar 11 with its saw chain 10 turns in the opposite direction compared to the pressing movement. In this way, the cutting saw is rotated, i.e. returned to the home position that is arranged for it in the cutting device 42, ready for the next cutting.

The control of the cutting device 42 can be implemented using the method according to Finnish patent number 123055. At present, the control operating in the simplest way is based on a throttle installed in the return line of the motor of the drive wheel 16. When the drive wheel's 16 motor 54 is running, pressure, which affects the feed, is obtained with the aid of the throttle for the hydraulic cylinder (rotation means) intended for the feed, i.e. the rotation of the guide bar 11. The greater the speed of the drive wheel's 16 motor, the greater is the feed pressure affecting the rotation of the guide bar 11, i.e. the loading of the guide bar 11 against the tree 18. When the drive wheel's 16 motor 54 stops, the pressure effect ends. The same control curve can naturally be implemented electronically and using software. The flow data is then collected using a suitable sensor. Using the sensor's data, the software means in turn regulate the pressure of the guide bar's 11 pressing cylinder.

The saw chain 10 arranged on the guide bar 11 of the cutting device 42 of the tree-handling device 40 includes links 20 connected to each other by connector elements 19, so that the saw chain 10 is an endless chain loop. As links 20, the saw chain 10 includes tooth links and drive links 12. The tooth links 21 include a cutting tooth 13, in which there is a depth adjustment tooth 15 and a cutting edge 24 arranged on one side of the saw chain 10. The drive links 12 are fitted into the groove 22 in the guide bar 11 on the opposite side of the saw chain 10. Several tooth links 21 are fitted consecutively to the saw chain 10 of the cutting device of the tree-handling device 40. In other words, consecutive tooth links 21 have been connected to the same one of said drive links 12.

In measurements of the saw chain 10 carried out in pilot-stage tests it has been shown that the weight of the saw chain 10 according to the invention increases by about 10%. Now, when the saw chain's 10 cutting capacity is about 100% greater with small trees and also in the final stage of cutting large trees, the speed of the saw chain 10 can be reduced. A reduction of speed by, for example, one half permits a cutting speed near to the previous one, but the kinetic energy of the saw chain 10 drops by about 70%. If the speed is reduced by only 30% of the original speed of the saw chain, in the case of a saw chain 10 according to the invention kinetic energy is created that is only about 60% relative to a known saw chain 10′.

Because the saw chain 10 saws more efficiently at a lower speed, with the toothing according to the invention a greater tensile stress is imposed on the saw chain 10. As an example, sawing at a speed of 30 m/s requires a power of about 30 kW, i.e. a tensile force of 1000 N acts of the saw chain. This is only about 10% of the ultimate load of the saw chain, so this force is not decisive.

The speed of the saw chain when cutting a tree 18 is arranged to be 20-35 m/s, 20-33 m/s, 20-30 m/s, or even more preferably 25-33 m/s. 30 m/s can be given as a specific example of the speed. In solutions according to the prior art, the speed of the saw chain 10′ can be 40 m/s. Due to the lower speed of the saw chain 10 relative to the prior art, lubricating medium also stays better in the saw chain 10. The lubrication of the sprocket 17 also improves as its speed is lower. All of this increases the life of the guide bar 11, the sprocket 17, and the saw chain 10. In addition, at a lower speed saw motors 54 with a higher torque can be used to drive the saw chain 10 according to the invention, compared to saw chains 10′ known from the prior art. When the chain speed is reduced, the creation of dangerous chain-bullets also diminishes considerably and the safety of sawing improves.

Low-revolution saw motors are more durable and other versions can also be used as motors. 14-cm³/r motors were used in the pilot-stage tests, but even greater efficiency can be achieved with a 19-cm³/r motor. For example, the length of the guide bar 11 may be 30-100 cm, and the power of the hydraulic saw motor 54 may be 20-100 kW. The guide bar length correlates with the power ranges. Extra power may be applied when faster cutting is needed.

One further aspect of the invention is also related to an elongated saw-chain blank 100, from which a saw chain 10 is arranged to be formed for the cutting device 42 of the tree-handling device 40. The saw-chain blank 100 can be shown by FIG. 5, which shows a top view of it. The saw-chain blank 100 includes links 20 connected to each other by connector elements 19′. As links 20, the saw-chain blank 100 includes drive links 12 and tooth links 21. The tooth links 21 each include a cutting tooth 13, in each of which an optional depth adjustment tooth 15 and a cutting edge 24 are arranged on an outer side of the saw-chain blank 100. From the saw-chain blank 100 a saw chain 10 can be formed, which is an endless chain loop that can be used in the cutting device 42 of the tree-handling device 40. The saw chain 10 is arranged to be rotated by its drive links 12 in the groove 22 arranged in the guide bar 11 of the cutting device 42. Several tooth links 21 are fitted consecutively to the saw-chain blank 100 in the manner described above. Again, consecutive tooth 21 links have been connected to a same one of the drive links 12.

The saw chain 10 is formed from the saw-chain blank 100 by cutting a suitably dimensioned saw-chain portion from it for the length of the guide bar 11, in which the tooth links 21 of the opposite ends cut on opposite sides to each other. The opposite ends of the saw-chain blank 100 are then joined together using a connector element 19′, in such a way that one drive link 12 comes between the consecutive tooth links 21 at the ends to be joined together. Thus, an endless chain loop forming an installation-ready saw chain is obtained, which can be installed in the groove 22 arranged for the saw chain around the guide bar 11 of the cutting device 42, travelling via the drive wheel 16 belonging to the cutting device 42.

The invention also further relates to a method for arranging the cutting operation of a timber-process device 40. In the method, the tree 18 is gripped before cutting it. Gripping can be performed using the gripping means 41 of the tree-handling device 40, such as, for example, grab claws 50. After gripping, the tree 18 is cut by sawing with the saw chain 10. During sawing, the saw chain 10 is circulated by the drive wheel 16 in the groove 22 arranged in the guide bar 11 of the cutting device 42. The saw chain 10 includes links 20 joined to each other by connector elements 19′, so that the saw chain 10 is an endless chain loop. As links 20, the saw chain 10 includes tooth links 21 and drive links 12. The tree 18 is cut by sawing, using the tooth links 21. The fibers of the tree 18 are then cut by the tooth links 21. Each tooth link 21 includes a cutting tooth 13, in which there is an optional depth adjustment tooth 15 and a cutting edge 24 on outer side of the saw chain 10. The saw chain's 10 drive links 12 are on the opposite side of the saw chain 10, relative to the optional depth adjustment tooth 15 and the cutting edge 24, in the groove 22 in the guide bar 11. In addition, the drive links 12 run via the drive wheel 16 belonging to the cutting device 42.

In the method, the travel of the tree 18 against the saw chain 10 is evened, i.e. its twisting in the sawing groove is reduced, by two or more tooth links 21 being arranged consecutively in the saw chain 10. In addition, in the method the saw chain 10 is also rotated during cutting at a speed of 20-35 m/s, or even more preferably 25-33 m/s. These advantages have been already stated above in the application's description.

During the cutting of the tree 18, the saw chain 10 is rotated around the guide bar 11 by a drive device (drive wheel 16, hydraulic motor 54) and the guide bar 11 is rotated by an operating device against the tree 18 being cut. The rotation of the guide bar 11 against the tree 18 being cut is controlled on the basis of the speed of the saw chain 10 or a comparable variable. As stated above, the speed of the saw chain 10 according to the invention can vary in different stages of the cutting. At the start and end of the cutting, the speed of the saw chain 10 can be higher, and the speed can be lower in the middle of the cutting, when the diameter of the object being cut is greatest. By adjusting the loading of the guide bar 11 against the tree 18 on the basis of this speed data, the speed of the saw chain 10 can be affected and thus sawing accelerated. When the speed of the saw chain 10 drops, the loading of the guide bar 11 can be correspondingly reduced. When the speed of the saw chain 10 is high, the loading of the guide bar 11 can also be kept high.

The saw chain 10 according to the invention is also suitable for cutting very small trees. In a conventional saw chain 10′ the cutting-tooth interval is about 40 mm, whereas in the saw chain 10 according to the invention it is about 20 mm. At the start of sawing the small branches have less chance of striking the body part of the saw chain 10, i.e. the level of the edge of intermediate links 14 form of only side plates 25, as these are not in the saw chain 10. Such a situation very typically occurs during felling cutting. Though the tree to be felled might be large, there are often branches in its butt area and before the saw chain 10 starts moving a branch or twig can come at an intermediate link in a known saw chain 10′ where there is no cutting tooth 13. Due to the great length of the working boom, the driver cannot see precisely the point in the tree where cutting will take place.

The construction according to the invention is suitable, for example, for saw chains 10, whose pitch is 10-20 mm (FIG. 6). For example, in the saw chains 10′, 10 of FIGS. 6 and 4a the pitch is about 10 mm. The width of the saw chain 10 can be, for example, 7+0.2 mm at the rivets 19 and 5.5+0.2 mm at the cutting tooth 13 and the side plate 25. The cutting tooth 13 too, especially its upper plate 28, can be narrowed. The cutting tooth 13 can be narrowed starting from its upper corner 26 to the rear edge 48 of the trailing edge of the upper plate 28. This narrows the width of the saw chain 10 compared to a known chain.

The bite of the cutting tooth 13 can also be reduced through the invention. The bite can be reduced compared to saw chains 10′ according to the prior art, in which the angle between the surface of the upper plate 28 of the cutting tooth 13 and the horizontal plane is, for example, about 9 degrees. In the saw chain 10 according to the invention, this angle can be surprisingly substantially smaller than in the known chain. An example of this angle is 0.5-7 degrees, 0.5-6 degrees, preferably 0.7-6 degrees, 0.7-5 degrees, and further, as specific examples, 7 degrees, 6 degrees, 5 degrees, 4 degrees, 3 degrees, 2 degrees, 1 degree, preferably 1-5 degrees. The small bite angle gives plenty of space for the chips created during sawing, which becomes less thick than in the prior art, due to the smaller bite angle.

In FIGS. 4a, 4b, and 5, a small gap can be seen between the consecutive links 20. However, the consecutive tooth links 21 can even touch each other, when the saw chain 10 is examined over its straight run. The adjustment tooth 15 of the next link 20 performing the depth adjustment in the consecutive links 20 is then situated at the rear edge 48 of the cutting tooth 13 of the previous link 20. Thus nothing fits in front of the cutting tooth 13. The only point in the saw chain 10 deviating essentially from a mainly straight line is between the adjustment tooth 15 and the cutting edge 24. Thus even small twigs cannot go between the links 20 to cause sharp impacts weakening the construction of the saw chain 10. The durability of the saw chain 10 thus improves and thus the thickness of the windshield 38 of the forest harvester 31 can be, for example, only 5-15 mm, because the risk of the saw chain 10 breaking is reduced.

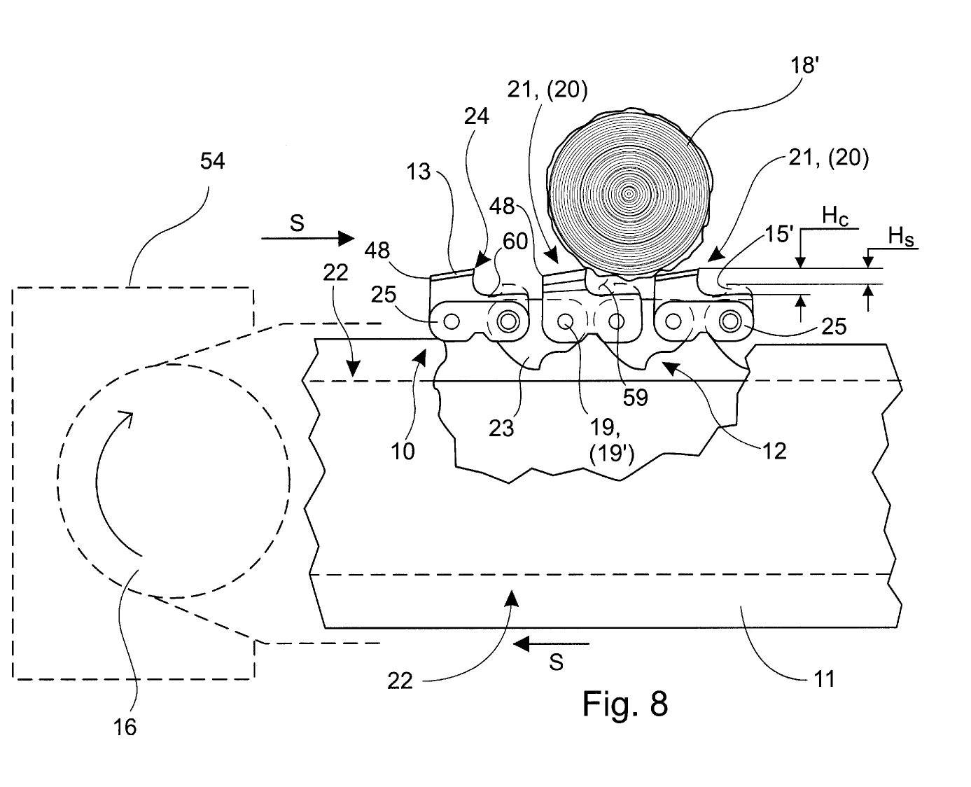

FIG. 8 shows yet another example of the saw chain 10, in which the tooth links 21 may even be without the depth adjustment tooth 15 that is present in the previously described examples. In other words, in this example the depth Hₛ of a space 59 between the consecutive cutting teeth 13 may mainly correspond to the height H_{c} of the cutting tooth 13 between the entire distance from the rear edge 48 of the previous cutting tooth 13 to the cutting edge 24 of the next cutting tooth 13.

On the other hand, the space 59 between consecutive cutting teeth 13 may be at least half free of structures in the direction of the height H_{c} of the cutting tooth 13. In that case, the height of the depth adjustment tooth 15 or a formation 15′ disposed in a corresponding location is less than 50% of the height H_{c} of the cutting tooth 13. Preferably, the height of the depth adjustment tooth 15 or a formation 15′, for example, in a corresponding location is less than 20% of the height H_{c} of the cutting tooth 13, but in any event is below 60% of the height H_{c} of the cutting tooth 13. In other words, the height of the depth adjustment tooth 15, for example, may be 1 to 60% of the height H_{c} of the cutting tooth 13. Thus, a depth Hₛ of a space 59 (defined by the outer edge of the formation 15′) between consecutive cutting teeth 13 is more than 40% of a height H_{c} of the cutting tooth 13. Here the height H_{c} of the cutting tooth 13 is a distance from the base 60 of the saw chain 10, i.e. from the base of the cutting tooth 13, to the cutting edge 24 of the cutting tooth 13. The base of the cutting tooth 13 corresponds mainly to the outer edge of the side plate 25. Correspondingly, the depth Hₛ of a space 59 is a (vertical) distance from the upper edge of the formation 15′ to the cutting edge 24 of the cutting tooth 13.

Owing to the consecutive cutting teeth 13, i.e. without the intermediate links 14 in the saw chain 10, the cutting depth H of the cutting tooth 13 can be maintained suitable by means of the cutting tooth 13 itself. The reduced bite angle also aids the cutting depth, and Hₘₐₓ therefore will be smaller. This simplifies the construction of the saw chain 10 and also eases its maintenance (for example, there is no need to adjust the height of the depth adjustment tooth).

In pilot-stage tests of the saw chain 10 according to the invention, the significant advantage has also be observed that the need for post-tensioning the saw chain 10 is clearly less than that of a saw chain 10′ known from the prior art. Thus cleaning can be performed with the same saw chain 10 for even a whole day, without post-tensioning of the saw chain 10. This is a result of the lower stress, of the even loading, of the more even wear in the guide bar, and also of the reduced vibration, which is a problem in known saw chains 10′, in the saw chain according to the invention. Due to this, the saw chain 10 works well even in felling heads without an automatic chain tensioner. In felling heads, the chain tensioner accounts for a relatively significant portion, of even thousands of Euros, of the total price of the felling head, so that savings are gained when investing in a felling head.

In addition, it has also be observed in pilot-stage tests that the saw cut of the saw chain 10 has a considerably smoother surface compared to the known technique. This positively affects, for example, colour markings made on sawn surfaces. Due to the surface smoothness they also adhere better to the wood and are clearer, making them also highly visible.

Above, the effect of the chain-bullet phenomenon was dealt with from the driver's point of view. The same phenomenon also endangers people in the vicinity. The hazard area around the work machine can be reduced by using the invention.

A first prototype of the invention has been tried in harvesters manufactured by Kone Ketonen Oy. “STIHL® Moto Chain” brand chains (groove widths 1.6 mm and 2.0 mm) marketed by Uittokalusto Oy (FI) were disassembled into components and reassembled according to the invention.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A cutting device comprising:
a generally planar guide bar having a peripheral groove;
an endless saw chain disposed around said guide bar and including links and connector elements joining said links to each other to form an endless chain loop;
said links including drive links and consecutive tooth links connected to a same one of said drive links;
each said tooth link including a cutting tooth protruding from one side of said saw chain, and consecutive cutting teeth of said tooth links being arranged to alternate to right and left sides relative to a plane defined by said guide bar;
said saw chain being operably circulated around said guide bar groove for cutting.

2. The cutting device of claim 1, wherein said drive links are fitted in said groove of said guide bar on an opposite side of said saw chain relative to said cutting teeth, and said tooth links and said drive links are alternately disposed in said saw chain.

3. The cutting device of claim 1, wherein said cutting teeth in consecutive tooth links are arranged to cut on opposite sides relative to each other.

4. The cutting device of claim 1, wherein said saw chain has a width that is 10%-40% greater than a width of said guide bar.

5. The cutting device of claim 1, wherein each said cutting tooth includes an adjustment tooth, and in the consecutive links, the adjustment tooth of a following link is disposed next to a position of a rear edge of the cutting tooth of a preceding link.

6. The cutting device of claim 1, wherein a bite angle of each said cutting tooth is 0.5-7 degrees.

7. The cutting device of claim 1, wherein a depth of a space between consecutive cutting teeth is more than 40% of a height of the cutting tooth from a base of the cutting tooth to a cutting edge of the cutting tooth.

8. The cutting device of claim 1, wherein clearance of the connector elements of the saw chain is arranged to limit the sidesway of the tooth links.

9. The cutting device of claim 1, wherein the guide bar has a length in a range of 30-100 cm.

10. The cutting device of claim 1, further including a hydraulic saw motor having a power in a range of 20-100 kW.

11. A cutting device as in claim 1 in combination with a tree handling device, said tree handling device comprising:
a gripper for gripping a tree.

12. A cutting device as in claim 1 in combination with a timber harvester, said timber harvester comprising:
a boom;
said cutting device being operably mounted on said boom.

13. The combination as in claim 12, wherein said timber harvester further comprises:
a motorized base machine;
a cab attached to said base machine, said cab including a windshield; and
a crane attached to said base machine, said crane including said boom.

14. The combination as in claim 13, wherein the windshield of said cab has a thickness of 5-15 mm.

15. A method of cutting with a cutting device as in claim 1, the method comprising the steps of:
gripping a tree before cutting it;
circulating said saw chain at a speed of 20-35 m/s; and
cutting the tree using said cutting device;
whereby twisting of said saw chain in a sawing groove is reduced by the arrangement of said tooth links consecutively in said saw chain and joining said several tooth links to a same said drive link.

16. The method of claim 15, wherein the step of cutting the tree further comprising the steps of:
operably circulating said saw chain around said guide bar using a drive device;
rotating said guide bar against the tree being cut; and
controlling the rotation of said guide bar against the tree being cut on the basis of one of the speed of the saw chain and another variable.
